(19) United States
(12) Patent Application Publication
(10) Pub. No.: US 2007/0124265 A1
(43) Pub. Date: May 31, 2007

(54) Complex system diagnostics from electronic manuals

(75) Inventors: Hari Prasad S Hebbani, Bangalore (IN); Vadiraj Joshi, Bangalore (IN); Murali Kadeppagari, Anathapur District (IN); Sandeep G. Kulkarni, Dharwad (IN); Aseem Nagar, Haryana (IN); Sreedharan Venkataraman, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/288,593

(22) Filed: Nov. 29, 2005

(51) Int. Cl. G06N 5/00

(52) U.S. Cl. 706/45

(57) ABSTRACT

In accordance with one aspect of the present invention, a method for implementing a diagnostic system pertaining to a complex system includes receiving, by a computer implemented system, an observed symptom that characterizes a discrepancy report of a complex system, associating the observed symptom with contents of at least one electronic manual to capture relevant information therefrom, and evaluating the relevant information by the computer implemented system to recommend at least one desired action for mitigation of the discrepancy report without assuming knowledge about a historical discrepancy report similar to the reported discrepancy.

### BACKGROUND OF INVENTION

The present invention relates generally to complex system diagnostics and may, for example, be particularly based on electronic manuals.

Complex systems often exhibit undesirable discrepancies due to reasons including, but not limited to, failure, wear, and malfunctions. For example, the engine of an aircraft may not start or may make abnormal noises. Those symptoms are often related to corresponding faults. With reference to the above example, the engine may not start if an ignition system of an engine is non-operational or if there is no fuel supply.

It may be critical to identify desired actions as soon as any undesirable symptoms are observed. Such desired actions may include potential diagnostic actions and/or corrective actions for mitigating (correcting) the faults associated with the observed symptom.

Generally, in conventional approaches, persons with expert knowledge of the equipment execute various desired actions, either by referring to maintenance manuals and/or relying on knowledge gained from prior occurrences of such failures. The manuals are often provided in the form of hardcopies, which are generally not accessible from many locations and may also add to the overall cost. In other conventional approaches, a knowledge base may be developed from a database of historical discrepancy reports and corresponding mitigation plans. The knowledge base may also be provided with troubleshooting and/or diagnostic information typically obtained from source documents such as maintenance manuals. Such a knowledge base may be used by typical computer implemented systems to recommend desired actions for mitigating reported discrepancies.

Reliance on expert knowledge provided by individuals may lead to unacceptably high costs and/or times for mitigating discrepancies reported in connection with complex systems. Further, a knowledge base containing discrepancy reports and their associated mitigation plans may have restrictions with respect to the type of knowledge existing in the knowledge base. For example, the type of knowledge required for diagnostics of some new equipment introduced into the complex system may be entirely different compared to any other prior equipment of the identical complex system. Accordingly, in order to appropriately update the knowledge base, pertinent documents relating to the new equipment need to be processed each time a discrepancy occurs in order to extract knowledge required to perform the necessary diagnostics. Moreover, use of databases to provide the knowledge base adds to the cost of the overall implementation of the diagnostic system. Such costs may be undesirably compounded by the overhead required to configure the databases with various types of information necessary to update the knowledge base.

In another conventional approach, manuals are provided in an electronic form accessible on networks such as world wide webs. A user may provide various types of input, and may search the electronic manuals using typical search engines. Generally, conventional text search engines are not capable of exploring associative relationships among various logical entities linked with the search results. More particularly, when using search engine type technologies, portions of the manuals matching the user inputs are displayed, but the displayed information may not be evaluated for association with specific guidance in the form of desired actions to correct the discrepancies.

Accordingly, there is a need to provide a cost effective and convenient implementation of (i) complex system diagnostics without intervention of a human expert and/or (ii) a system without having diagnostic knowledge base. A historical knowledge of discrepancies is not required.

### SUMMARY OF THE INVENTION

In accordance with one aspect of the present invention, a method for implementing a diagnostic system comprises the following: receiving an observed symptom that characterizes a discrepancy report of a complex system, wherein the observed symptom is received by a computer implemented system; associating the observed symptom with contents of at least one electronic manual to capture relevant information therefrom; and, evaluating the relevant information by the computer implemented system to recommend at least one desired action for mitigation of the discrepancy report without assuming knowledge about a historical discrepancy report similar to the reported discrepancy.

In accordance with another aspect of the present invention, a method for implementing a diagnostic system comprises the following: receiving an observed symptom that characterizes a discrepancy report of a complex system, wherein the observed symptom is received by a computer implemented system; associating the observed symptom with contents of a plurality of electronic manual conforming to a SGML format to capture relevant information therefrom; and, evaluating the relevant information by the computer implemented system to recommend at least one corrective action for mitigation of the discrepancy report without assuming knowledge about a historical discrepancy report similar to the reported discrepancy. The corrective action is evaluated from data characterizing an association of each of a plurality of standard symptoms to corresponding ones of a plurality of diagnostic faults and an association of each of the plurality of diagnostic faults to corresponding ones of a plurality of corrective actions.

In accordance with yet another aspect of the present invention, a computer readable medium carries one or more sequences of instruction for causing a digital processing system to implement a diagnostic system. The sequences of instruction are performed by at least one processor to execute the following functions: receiving an observed symptom that characterizes a discrepancy report of a complex system; associating the observed symptom with contents of at least one electronic manual to capture relevant information therefrom; and, evaluating the relevant information by the digital processing system to recommend at least one desired action for mitigation of the discrepancy report without assuming knowledge about a historical discrepancy report similar to the reported discrepancy.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram depicting one embodiment of a diagnostics system according to an aspect of the present invention;

FIG. 2 is a flow chart representing one implementation of the diagnostics system shown in FIG. 1;

FIG. 3 is a diagram depicting an example of a general relationship amongst standard symptoms, faults, and desired actions according to an aspect of the present invention;

FIG. 4 is a diagram depicting an exemplary information structure of a typical electronic manual having trouble shooting guidelines used for diagnostics of the complex systems within the scope of the present invention;

FIG. 5 is a flow chart depicting a way for correlating observed symptoms with relevant standard symptoms using the computer implemented system in accordance with aspects of the present invention;

FIGS. 6A through 6D together depict the manner in which a typical example is processed in accordance with aspects of the present invention;

FIGS. 7A through 7B together depict the manner in which the example of FIGS. 6A through 6D is processed to generate a typical frequency vector for an example of an observed symptom in accordance with aspects of the present invention; and,

FIG. 8 is a block diagram illustrating the details of a digital processing system according to an embodiment of the present invention.

### DETAILED DESCRIPTION

A digital processing system according to one embodiment of the present invention receives from a user (such as a diagnostician) an observed symptom that typically characterizes a discrepancy report of a complex system. The observed symptom is associated with the contents of one or more electronic manuals in order to capture information relevant to the observed symptom. Such relevant information is further evaluated by the digital processing system so as to recommend one or more corrective actions to the user that will, if taken, mitigate the discrepancy report. Such recommendations may be displayed to the user to enable him/her to act accordingly.

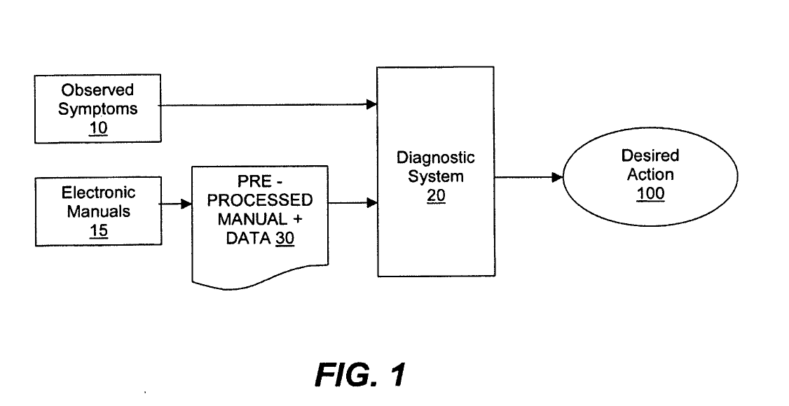

FIG. 1 is a block diagram depicting a diagnostic system 20 that receives one or more electronic manuals 15 typically in form of a pre-processed electronic manual 30. The diagnostic system 20 also receives an observed symptom 10 (which, for example, may be input by the user) and outputs recommended desired actions 100 to the user.

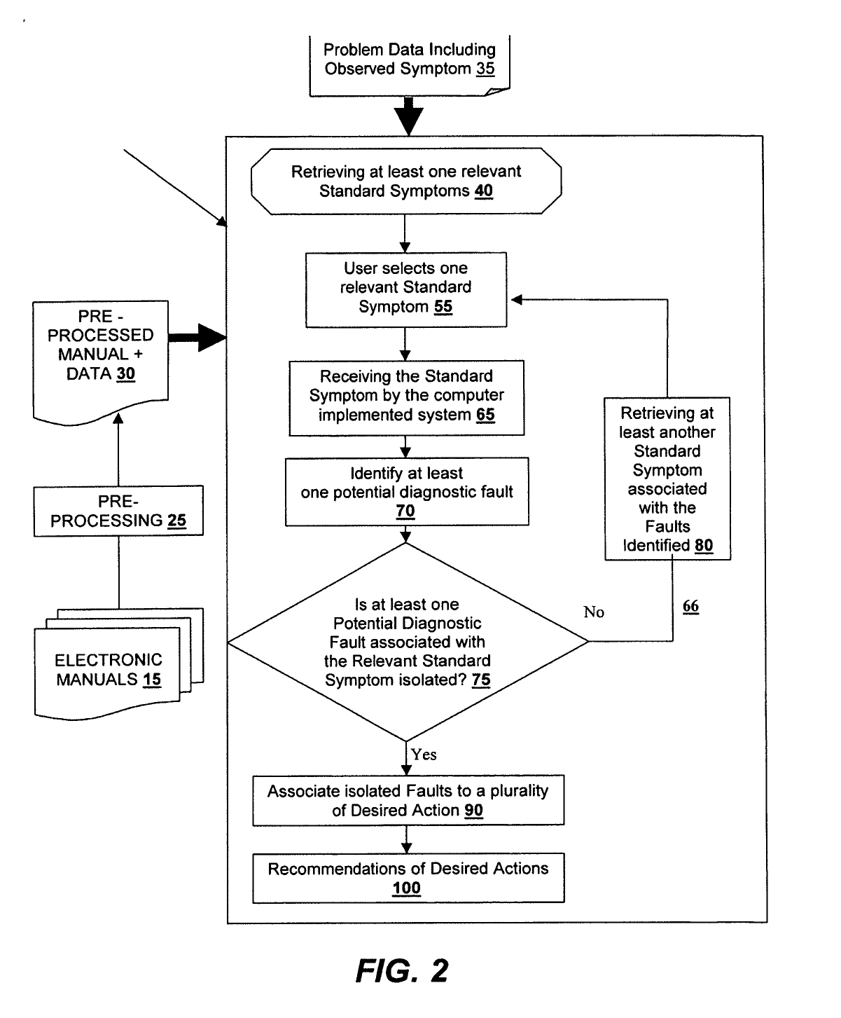

FIG. 2 is a flow chart depicting an example of a diagnostic system that may be used for the diagnostic system 20. Input data is provided to the diagnostic system of FIG. 2. The input data, for example, may include data relating to equipment type and equipment number and also includes the observed symptom 10 and is generally provided to the diagnostic system 20 either through such text input devices as keyboards, through the use of voice-recognition technologies, or through the use of other input devices capable of providing useful inputs to the diagnostic system 20. Also supplied to the diagnostic system 20 is the pre-processed electronic manual 30. The pre-processed electronic manual 30 may be stored in the form of a database. The diagnostic system 20 includes a first step 40 of retrieving at least one (i.e., one or more) relevant standard symptom from the pre-processed electronic manual 30. Such retrieval is performed at the step 40 by correlating the observed symptom 10 input at step 35 with the standard symptoms contained in the pre-processed electronic manual 30. The user may select at step 55 one relevant standard symptom retrieved from the pre-processed electronic manual 30 at step 40. Alternatively, the diagnostic system 20 can be arranged to automatically select one of the standard symptoms at step 55 for processing by a loop 66 comprising the steps 55-80. At step 65, the selected relevant standard symptom is received by the computer implemented diagnostic system 20. Further, at step 70, at least one potential diagnostic fault is identified in accordance with the selected relevant standard symptom. At least one potential diagnostic fault may be identified from the pre-processed electronic manual 30 which stores one or more diagnostic faults in association with each of the standard symptoms. At step 75, the computer implemented diagnostic system 20 determines whether at least one potential diagnostic fault can be isolated from the one or more potential diagnostic faults identified at step 70 depending on its association with the relevant standard symptom. More particularly, at step 75 the computer implemented system attempts to zero in on the potential diagnostic faults associated with the relevant standard symptom. If the computer implemented diagnostic system 20 cannot isolate the potential diagnostic faults, step 80 is executed to retrieve at least another of the standard symptoms associated with the faults identified at 70. In other words, if a selected standard symptom is associated with more than one fault, then there needs to be a method to isolate the correct fault by providing another set of associated standard symptoms which is calculated from the above identified faults.

For illustration purposes, it may be assumed that an exemplary observed symptom characterized by the user in a discrepancy report is “Landing Gear Fault.” The computer implemented diagnostic system 20 may retrieve at step 40 the following list of exemplary relevant standard symptoms including, without limitation, (A) “Landing gear not down,” (B) “Landing gear keep down,” and (C) “Landing gear shock absorber problem.” If option (B) is selected at step 55 in FIG. 2, it may be that potential diagnostic faults associated with this selected relevant standard symptom are not isolated at step 75. In this case, another set of standard symptoms will be retrieved by the computer implemented diagnostic system 20 at the step 80. Such a set of standard symptoms by way of example may include, without limitation, (B1) “Red arrow down” and (B2) “Control lever down.” Accordingly, steps 80, 55, 65, 70, and 75 may be iterated (i.e., repeated) in the loop 66 as depicted in FIG. 2 until at least one potential diagnostic fault associated with the relevant standard symptom retrieved is isolated.

The electronic manuals 15 used by the diagnostic system 20 may be of various types including, without limitation, troubleshooting documents, maintenance manuals, parts catalogues, schematic manuals, and wiring manuals. At step 90, the at least one isolated fault is associated with a plurality of desired actions included in the version of the pre-processed electronic manual 30 provided to the diagnostic system 20. Further at step 100, at least one of such desired actions is recommended to the user. In the example described in the previous paragraph, the exemplary desired actions recommended to the user may include (A) Replace the lever per trouble shooting document ZZZ, or (B) Replace the lever gear part number XXX per parts catalogue YYY. In one implementation, the desired actions associated with the isolated faults are identified as typical text block entities from the electronic manuals 15 under processing. Once relevant text blocks are identified, they may desirably be processed further to identify and format user specified text entities. Such text extraction inventions are well known. In one embodiment, these text extractions may be performed by using “Text Extraction Module Algorithms” disclosed by patent publication number WO0169527A2 (assigned to the common assignee of this application) which is incorporated herein by reference. It may be noted from the example discussed in accordance with the present invention that the desired actions may further include relevant part numbers of the components subjected to desired actions and relevant section references from the pre-processed electronic manual 30 being processed by the computer implemented diagnostic system 20.

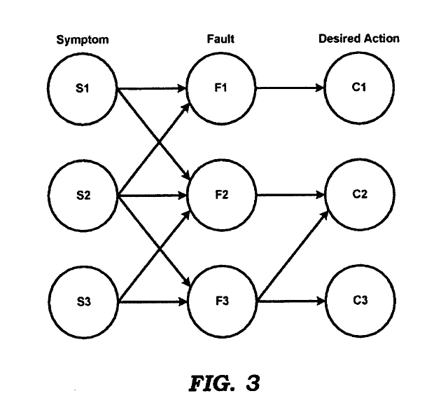

FIG. 3 is a diagram illustrating a conceptual relationship depicting an association among entities of the electronic manual (either the raw manuals 15 of the preprocessed manual 30). These entities, for example, may be standard symptoms, diagnostic faults, and desired actions that are typically used to implement the diagnostics system 20. It may be apparent from the description below that the fault isolation executed at step 75 of FIG. 2 and the desired action association executed at step 90 of FIG. 2 may be better understood by referring to FIG. 3. In general, the electronic manual available for processing typically includes data characterizing a plurality of standard symptoms, a plurality of potential diagnostic faults pertaining to the complex system, a plurality of desired actions including corrective actions, an association between the plurality of standard symptoms and the plurality of diagnostic faults, and an association between the plurality of diagnostic faults and the plurality of desired actions.

By way of example, FIG. 3 depicts standard symptoms S1, S2, and S3, diagnostic faults F1, F2, and F3, and desired actions C1, C2, and C3, and various arrows representing the associations therebetween as discussed above. It may be appreciated that each such standard symptom represents an observed and/or felt symptom that the electronic manual is able to recognize and to associate with one or more faults such as, for example, a malfunction, a sub-optimal operation, wear, and so forth. In one embodiment, the desired actions represent corrective actions. In other embodiments, such desired actions generally include further diagnostic follow ups.

In accordance with the diagram of FIG. 3, the relevant standard symptom S1 may be observed when fault F1 and/or F2 is present. Similarly, the relevant standard symptoms S2 and S3 are respectively associated with fault sets {F1, F2, and F3} and {F2, F3}, as shown. On the other hand, faults F1, F2, and F3 may be viewed as causes of the observed relevant standard symptom sets of {S1, S2}, {S1, S2, S3}, and {S2, S3}, respectively. Further, FIG. 3 depicts association of diagnostic faults with desired actions. Accordingly, it may be observed that exemplary corrective action sets of {C1}, {C2}, and {C2, C3} are associated with diagnostic faults F1, F2 and F3, respectively.

As shown in FIG. 3, and assuming that the relevant standard symptom S2 has been retrieved at step 40 based on the observed symptom 10, and further assuming that the potential diagnostic faults {F1, F2, and F3} have been determined at step 70, it may be implied that the relevant standard symptoms {S1 and S3} are identified at step 80 and form the set of those relevant standard symptoms which would desirably isolate the potential fault at step 75 by iterating through the loop 66, since the fault F1 would be the unique fault if only the standard symptom S1 is present (along with the standard symptom S2), and the fault F3 would be the unique fault if only the standard symptom S3 is present (along with the standard symptom S2). In step 100 of FIG. 2, desired actions are recommended corresponding to the isolated fault (in the example above, the fault F1). Furthermore, all the desired actions corresponding to the isolated fault may be displayed. For example, assuming that F3 is determined as the only potential fault, actions C2 and C3 may be displayed as the desired actions. (Therefore, it may be understood that the diagnostic system 20 evaluates associative information of the observed symptom with contents of the electronic manual to recommend at least one desired action to the user for mitigation of the discrepancy report. Further, in sharp contrast with conventional techniques prevailing in the related art, it may be apparent that the present technique beneficially obviates the need for prior knowledge about any historical discrepancy reports similar to the reported discrepancy or for a priori knowledge derived from such documents as troubleshooting documents for example. These benefits may be attributed to the aspect of associative evaluation of the observed symptom with the contents of the electronic manual 15 as explained above. However, the desired actions may be identified based on version of electronic manual available for processing.

The data stored in electronic manuals generally conform to a structured format typically followed by any markup language. In one embodiment, such a markup language includes a standard generalized markup language (hereinafter “SGML”) structured format. The SGML structured format enables authors of electronic manuals to mark up their documents by representing structural, presentational, and semantic information alongside content. It may be appreciated by persons skilled in the art that the SGML structured format desirably serves to represent or “tag” the logical structure of information included in a document. This representation is independent of the systems used. Accordingly, SGML may be used as an exemplary standard for file representation and exchange complying with aspects of the present invention.

It may be appropriate to note that, unlike other formats that contain only data, the SGML structured format contains both data and meta-data. Further, the SGML format generally separates content, format, and keys. Further, it also provides application independency with respect to format, page, size, and navigation. For each type of manual, a generic structure or schema called data type definition (hereinafter “DTD”) is defined. DTD generally defines the typical syntax of markup constructs. The DTD schema may include a root node and various child nodes that further define the tagging rules of the data structure of each document. Each tag also includes a portion of the text, or more hierarchical tags at a lower level representing sub-portions of the text. Further, the DTD schema specifies the tags that are allowed in a document. The text in a tag of a node may also contain references to other tag(s) in the same node or another node of the tree representation, representing the relationship between various tags. Such relations are used to indicate different symptoms corresponding to the fault or the desired actions corresponding thereto. The relationship between various tags aids in the evaluation of which of the potential diagnostic faults might have caused the observed symptoms and the desired actions associated therewith.

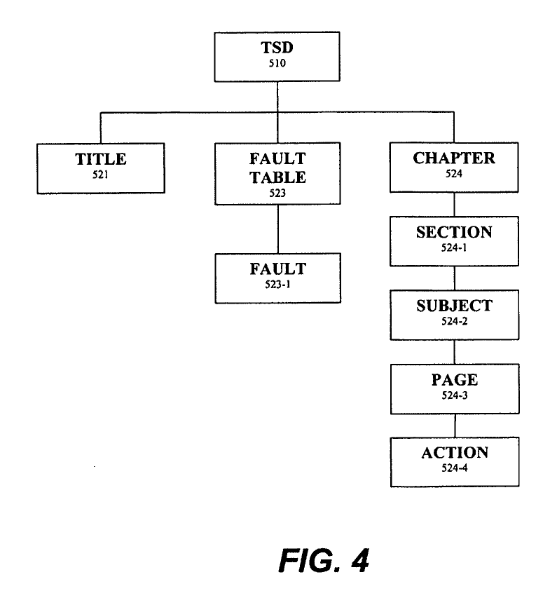

It may further be apparent that implementation of text-mining inventions depends on the DTD representation of an electronic manual being examined. The description below is continued with exemplary reference to a “troubleshooting document” (hereinafter “TSD”) depicted in FIG. 4. However, such description does not limit the present invention to any embodiment of an electronic manual used for any specific application. Accordingly, FIG. 4 may be construed as merely an example to demonstrate how the DTD schema aids in the text mining process.

The exemplary trouble shooting document structure depicted in FIG. 4 includes a root node 510 (with label TSD) and child nodes, such as “TITLE” 521, “FAULT TABLE” 523, and “CHAPTER” 524. The child node “TITLE” 521 characterizes the document title to identify the document from which the data is being extracted. The child node “FAULT TABLE” 523 includes a group of many potential faults. Each potential fault may further be identified by a fault reference key for fault identification. Further, a set of corresponding symptoms are tagged with a fault reference key. In implementation, node “FAULT” 523-1 (a hierarchical child node under “FAULT TABLE” 523) desirably include tags representing standard symptom association references to corresponding faults and desired actions to mitigate the faults.

The child node “CHAPTER” 524 typically identifies the system subjected to trouble shooting. For example, if the troubleshooting document pertains to an aircraft system, “CHAPTER” 524 may include sub-chapters having tags such as “ATA 21” referencing air conditioning, “ATA 32” referencing landing gear, “ATA 36” referencing pneumatic system, and so forth. “SECTION” 524-1 is a hierarchical node under “CHAPTER” 524 that identifies further segregation of the chapter represented by the node “CHAPTER” 524. For example, with respect to the sub-chapter “ATA 21” referencing “Air conditioning”, sections can be further segregated by the section identifiers such as 21-00 referencing “General”, 21-10 referencing “compression”, 21-20 referencing “Distribution”, 21-30 referencing “Pressurization Control,” etc.

Child node “SUBJECT” 524-2 under “SECTION” 524-1 further identifies the topic or subject under each of the section reference identified in “SECTION” 524-1. Further to the example recited in previous paragraph, under section 21-20 corresponding to “Distribution”, subjects may be referenced to “Introduction”, “Description”, “Operation,” and so on.

Child node “PAGE” 524-3 under “SUBJECT” 524-2 further identifies the page number having the actions. The actions are represented as child node “ACTION” 524-4 under “PAGE 524-3”. Title of the actions represent the fault under consideration and/or identified. The actions further include an action reference key which can be linked with the fault reference key associated with the fault. The action also includes the desired steps for mitigating the fault. Moreover, it also contains the relevant cross-references to other documents which might be required to mitigate the fault characterized by the discrepancy report.

FIG. 5 is a flow chart depicting an approach to correlating observed symptoms with standard symptoms at step 40 of FIG. 2 using the computer implemented system in accordance with some aspects of the present invention. Broadly, the approach relates to inverse document frequency related methods. The execution of the correlation process starts at step 801. Step 810 is executed during the preprocessing phase 25 (shown in FIG. 2) where the standard symptoms are typically accumulated across electronic manuals. This accumulation is accomplished by a first step (not shown) of cleaning the semantic structure of each of the standard symptoms available across the electronic manuals by extracting distinct words therefrom, and by a second step 810 of generating a term frequency matrix by use of the computer implemented system in accordance with one aspect of the present invention. Each column of the term frequency matrix represents a term characterizing a distinct word extracted from the standard symptoms, and each row represents a corresponding standard symptom. Each entry in the term frequency matrix typically represents a relative weight to be accorded if the corresponding term characterizing the distinct word is found in the corresponding standard symptom. It may be understood that step 810 may need to be performed only once for each electronic document. Accordingly, results of step 810 may be conveniently stored in a non-volatile memory for later use. A single matrix may be created from all electronic manuals that are processed, if so desired.

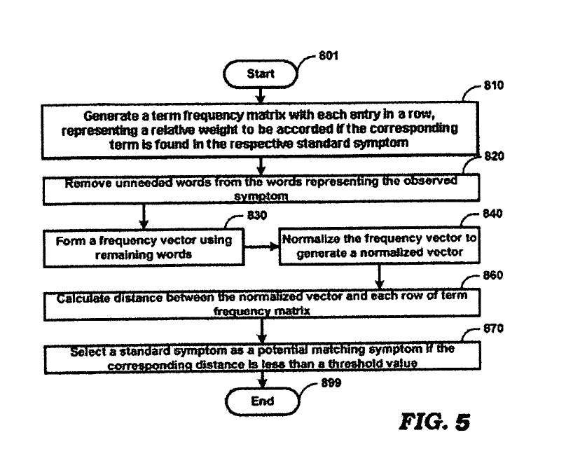

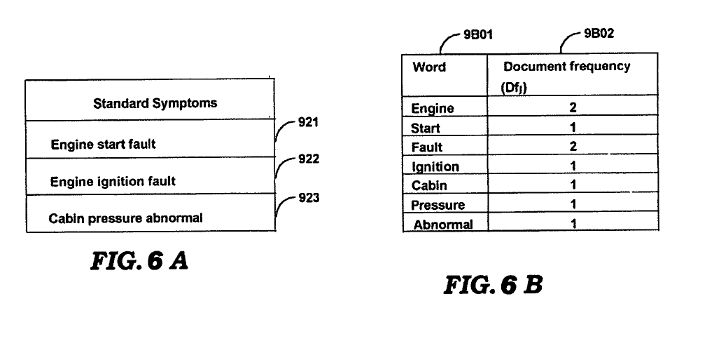

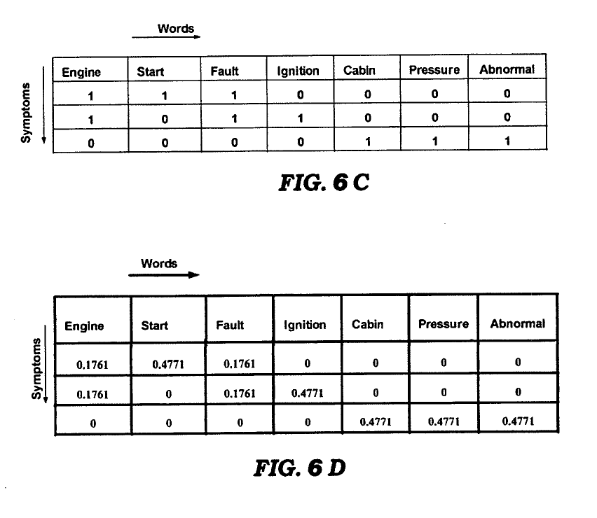

FIGS. 6A-6D together illustrate the manner in which a term frequency matrix is generated in one embodiment. Merely for example, it is assumed that an electronic manual includes three standard symptoms, shown as rows 921, 922 and 923 respectively in FIG. 6A. Thus, each row includes text representing the corresponding standard symptom. The manner in which the term frequency matrix may be generated for the standard symptoms of FIG. 6A is described further with reference to FIGS. 6B through 6D. FIG. 6B depicts an example table indicating a list of distinct terms in the standard symptoms of FIG. 6A, and a corresponding frequency of occurrence of each word in the electronic manual. Accordingly, the exemplary table of FIG. 6B is shown to contain two columns, column 9B01 containing each of the distinct terms in the example standard symptoms of FIG. 6A, and column 9B02 indicating a corresponding frequency of occurrence of each distinct term in the electronic manual. Thus, the terms/words engine, start, fault, ignition, cabin, pressure, and abnormal are shown respectively occurring 2, 1, 2, 1, 1, 1, and 1 times.

FIG. 6C represents an exemplary intermediate table, with each row corresponding to a corresponding standard symptom and each column representing a distinct word/term. An entry in the table indicates the number of occurrences of that distinct word in that particular standard symptom. Thus, the first row indicates that terms 1, 2 and 3 are present, that each term 1, 2, and 3 occurs once in the first standard symptom of the table depicted in FIG. 6A, and that the other terms of table depicted in FIG. 6B are absent in the first standard symptom. Similarly, the last row indicates that terms 1, 2, 3 and 4 are absent in the last standard symptom of the table depicted in FIG. 6A. FIG. 6D represents an example of a term frequency matrix generated from the table of FIG. 6C according to one embodiment of the present invention. Thus, each entry of FIG. 6D (in the i^{th} row and j^{th} column) may be computed in accordance with the following mathematical expression:

| Entry (i, j) = | (1 + log ( tfᵢⱼ)) log ( N / dfⱼ) | if | tfᵢⱼ >= 1 |
|---|---|---|---|
| | 0 | if | tfᵢᵢ = 0 |

In the above expression, tfᵢⱼ represents the term frequency (i.e., the number of occurrences of the word in the entry at the intersection of the jth column and ith row), N represents the aggregate number of standard symptoms, and dfⱼ represents the total number of occurrences of the term in the standard symptoms. The values for tfᵢⱼ may be ascertained from the table of FIG. 6C, and the values for dfⱼ from the table of FIG. 6B. As an example, the entry for engine at symptom 1=(1+log(1))log (3/2)=0.1761 since engine (tᵢⱼ) occurs only once in the entry at the first column and the first row of FIG. 6C, the total number of symptoms (i.e., row) N=3, and the total number of occurrences dfⱼ of the term engine from FIG. 6B is 2.

As again shown in FIG. 5, it may be noted that, at a step 820, the processing of the observed symptoms is started by removing unneeded words (e.g., stop words) from the received words representing observed symptoms. More particularly, cleaning of the semantic structure of the observed symptom is performed. It may be recalled that those observed symptoms characterize discrepancy reports. Typical stop words identified in the observed symptom are removed, and remaining words are preserved using one of several text processing approaches well known in the relevant arts. Typical stop words include “and,”, “or,” etc. Moreover, additional processing may also be performed on the words forming observed symptoms. For example, a user may use synonyms, different tenses such as past tense or present tense, plural and singular, and/or informal words to describe an observed symptom. Various approaches well known in the relevant art may also be used to address such semantic challenges. For example, a received word may be substituted by a synonym or the longest synonym may be used in both the term frequency matrix and the observed symptom before executing step 830. Similarly, stemming may be performed to convert each word from past tense to present tense, plural to singular, and so on.

As further shown in FIG. 5, in step 830, a frequency vector is desirably formed using the words of the observed symptoms that remain after the step 820 processing. In step 840, the frequency vector is normalized to generate a normalized frequency vector. Generally, the normalization of the frequency vector ensures that the occurrence of any term/distinct word appearing in the observed symptom is given due weight while correlating the observed symptom with the relevant standard symptom. The frequency vector is typically represented by a single row (i=1) having a number of entries equaling the number of columns in the term frequency matrix. Further, the normalized frequency vector may be generated according to the following formula:

| | | |
|---|---|---|
| ent(1, j) = (1 + log(tf₁ⱼ))log(N/dfⱼ) | if | tf₁ⱼ ≧ 1 |
| ent(1, j) = 0 | if | tf₁ⱼ = 0 |

where tf₁ⱼ represents the number of occurrences of the jth word in the observed symptom, ent(1,j) represents an entry of the vector, N represents the aggregate number of standard symptoms, and dfⱼ represents the total number of occurrences of the term in the standard symptoms.

In an exemplary illustration, the normalized value for the term “engine” which appears in the standard symptoms of rows 921 and 922 of FIG. 6A may be obtained by using the value of the number of occurrences of the term “engine” in each standard symptom from FIG. 6C, the total number of occurrences (dfⱼ) of the term “engine” (which has a value of 2) in the electronic manual of FIG. 6B, and N=3 given that there are 3 standard symptoms in the illustrative example. If the term “engine” occurs only once in the observed symptom, the normalized value of the term “engine” may be computed as tf_{engine}=(1+log (1)) log (3/2)=0.1761. Similarly corresponding normalized values of other entries may also be computed for each term of FIG. 6C.

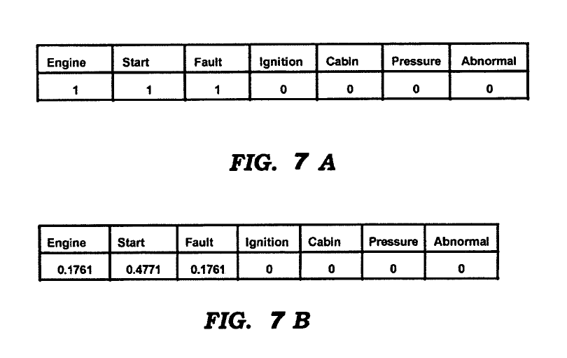

In step 860, a distance between the normalized frequency vector and each row of the term frequency matrix is evaluated. This distance generally represents the relative degree of correlation of the observed symptom with the relevant standard symptom. FIGS. 7A and 7B depict an example of generating a normalized frequency vector for an observed symptom according to an embodiment of the present invention. The manner in which the normalized frequency vector is used for distance computation is described subsequently. For example purposes, it is assumed that an observed symptom is represented by a text string “engine start fault found”. Thereafter step 820 may be executed to obtain the text “engine start fault” by removing the stop work “found.”

FIG. 7A represents a frequency vector for the example observed symptom stated above. Each entry of FIG. 7A corresponds to a distinct word or term of FIG. 6B. The presence of each word or term in the observed symptom is indicated by a non-zero value representing the number of occurrences of the term in the observed symptom and by a “0” value representing the absence of the term in the observed symptom. Thus, values corresponding to the distinct words/terms engine, start, and fault are represented by a “1” value in FIG. 7A, and the remaining entries are represented by a “0” value. The frequency vector for the observed symptom of FIG. 7A may be normalized using corresponding values of FIG. 6B in a similar approach as described above with reference to step 840. Thus, a normalized vector of [0.1761, 0.4771, 0.1761, 0, 0, 0, 0] may be generated as depicted in FIG. 7B.

It may be appreciated that a substantial number of entries of the inverse document frequency matrix and the normalized/frequency vectors equal 0, and accordingly the related data may be stored while minimizing the storage requirements. For example, sparse matrix type systems (in which only the row/column numbers of entries having non-zero values and the corresponding values are represented, leaving out all the zero value entries) well known in the relevant arts may be used.

Once the normalized vector is generated for the observed symptom, the distance between each of the standard symptoms and the normalized vector may be determined in accordance with step 860 of FIG. 5 in accordance with the following equation:
Distance=a cos {(x₁y₁+x₂y₂+ . . . )/[Sqrt(x₁²+x₂²+ . . . )*Sqrt(y₁²+y₂²+ . . . )]}
In above expression, a cos represents a cosine inverse trigonometric relationship, yᵢ represents the i^{th} entry of the row in the normalized term frequency matrix (FIG. 6D) corresponding to the standard symptoms, Sqrt represents the square root mathematical operation, and xⱼ represents the j^{th} entry of the normalized vector determined from the observed symptom. A distance between each standard symptom of FIG. 6A and the observed symptom of FIG. 7B may be determined using the equations and approaches described above. It may be appreciated from the equation immediately above that a value of a cos(0) results a distance=1.5708 units (maximum; radians) indicating the least degree of correlation of the observed symptom with the relevant standard symptom. Further, a value of a cos (π/2) results in a distance=0 units (minimum; radians) indicating the highest degree of correlation of the observed symptom with the relevant standard symptom. Thus, the maximum and minimum value of the distance should correspond to a cos(0) and a cos(π/2). Further, the correlation between the observed symptom and the relevant standard symptom may be ranked based on the distance value computed from the above equation.

Applying this distance equation to each of the three standard symptoms in relation to the exemplary normalized vector of FIG. 7B, distances of 0, 1.355 and 1.5708 are attained for the three standard symptoms, respectively. Once the distances are determined, the relevant standard symptoms may be determined by comparing with a threshold value to eliminate potentially irrelevant standard symptoms. As an example, the threshold value may be chosen corresponding to the distance value indicating the least degree of correlation (i.e. d=a cos(0)) of the observed symptom with the relevant standard symptom. Therefore, according to this example, a standard symptom is considered to pass a threshold requirement for being a relevant standard symptom if the corresponding distance is less than 1.5708 units. Accordingly, at step 870 of FIG. 5, a standard symptom is selected as a relevant standard symptom if the corresponding distance is less than the threshold value as discussed above. The method ends in step 899.

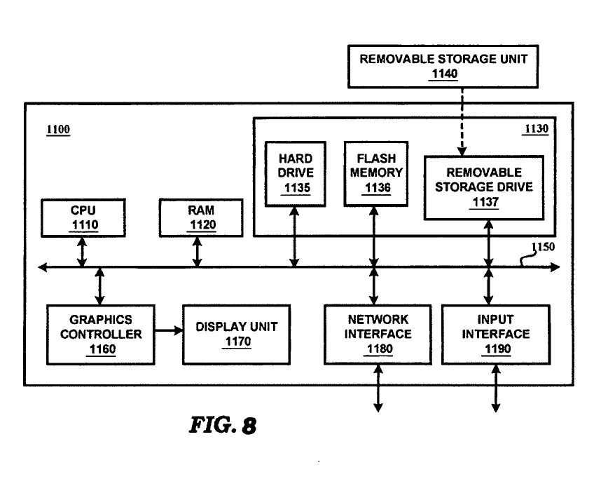

FIG. 8 is a block diagram illustrating the details of a digital processing system 1100 according to an embodiment of the present invention. The system 1100 may correspond to the diagnostics system 20 depicted in FIG. 1 The system 1100 may contain one or more processors, such as a central processing unit (CPU) 1110, a random access memory (RAM) 1120, a secondary memory 1130, a graphics controller 1160, a display unit 1170, a network interface 1180, and an input interface 1190. All the components except the display unit 1170 communicate with each other over a communication path 1150, which contains several buses as is well known in the relevant arts. The components of FIG. 8 are described below in further detail. The CPU 1110 desirably executes instructions stored in the RAM 1120 to execute several aspects in accordance the present invention.

The CPU 1110 comprises, for example, multiple processing units, with each processing unit potentially being designed for a specific task. Alternatively, the CPU 1110 may contain only a single general purpose-processing unit. The RAM 1120, for example, receives instructions from the secondary memory 1130 using the communication path 1150. The graphics controller 1160 generates display signals (e.g., in RGB format) to the display unit 1170 based on data/instructions received from the CPU 1110. The display unit 1170 contains a display screen to display the images defined by the display signals. The input interface 1190, for example, comprises to a keyboard and/or mouse. The graphics controller 1160 and the input interface 1190 enable a user to provide observed symptoms and determine the desired actions using various features of the present invention.

The secondary memory 1130, for example, comprises a hard drive 1135, a flash memory 1136, and a removable storage drive 1137. The secondary memory 1130 stores data (e.g., term frequency matrix) and software instructions, which enable the system 1100 to provide several features in accordance with the present invention. Some or all of the data and instructions may be provided on the removable storage unit 1140, and the data and instructions may be read and provided by a removable storage drive 1137 to the CPU 1110. Floppy drive, magnetic tape drive, CD-ROM drive, DVD drive, flash memory, removable memory chip (PCMCIA card, EPROM) are examples of such the removable storage drive 1137.

The removable storage unit 1140, for example is implemented using a medium and a storage format compatible with the removable storage drive 1137 such that the removable storage drive 1137 can read the data and instructions. Thus, the removable storage unit 1140 includes a computer readable storage medium having stored therein computer software and/or data.

The term “computer program product,” if used herein, refers to a storage medium such as the removable storage unit 1140, a hard disk installed in the hard drive 1135, a chip configured to execute certain functions, etc. A computer program product can be used to provide software and/or firmware to the system 1100. The CPU 1110 retrieves the software and/or firmware instructions, and executes the instructions to provide various aspects of the present invention as described above.

As discussed above, the observed symptoms are entered into the diagnostic system 20 by the user. Instead, various sensors can be located throughout the complex system to automatically supply symptoms sensed by the sensors to the diagnostic system 20. Similarly, corrective actions are provided to the user by way of a display so that the user can manually implement the corrective actions.

It will be apparent to those skilled in the art that, although the invention has been illustrated and described herein in accordance with specific embodiments, modification and changes may be made to the disclosed embodiments without departing from the true spirit and scope of the invention. It is, therefore, to be understood that the appended claims are intended to cover all such modifications and changes as fall within the true spirit and scope of the invention.

1. A method for implementing a diagnostic system comprising:
receiving an observed symptom that characterizes a discrepancy report of a complex system, wherein the observed symptom is received by a computer implemented system;
associating the observed symptom with contents of at least one electronic manual to capture relevant information therefrom; and,
evaluating the relevant information by the computer implemented system to recommend at least one desired action for mitigation of the discrepancy report without assuming knowledge about a historical discrepancy report similar to the reported discrepancy.

2. The method of claim 1, wherein the contents of the electronic manual comprises data characterizing a plurality of standard symptoms, a plurality of potential diagnostic faults pertaining to the complex system, a plurality of desired actions representing the corrective action, an association of each of the plurality of standard symptoms to corresponding ones of the plurality of diagnostic faults, and an association of each of the plurality of diagnostic faults to corresponding ones of the plurality of desired actions.

3. The method of claim 1, wherein the electronic manual conforms to a markup language.

4. The method of claim 3, wherein the markup language comprises a SGML structured format.

5. The method of claim 1, further comprising querying the electronic manual selected from the group consisting of a trouble shooting document, a schematic manual, a maintenance manual, a parts catalogue, and a wiring manual.

6. The method of claim 5, further comprising:
(a) retrieving one or more relevant standard symptoms from the electronic manual by correlating the observed symptom with the standard symptoms using the computer implemented system;
(b) selecting one relevant standard symptom;
(c) identifying at least one potential diagnostic fault associated with the selected relevant standard symptom;
(d) determining whether the potential diagnostic fault is isolated based on an association of the fault with the selected relevant standard symptom;
(e) retrieving at least another standard symptom associated with the potential diagnostic faults identified at (c) in case of non-isolation thereof;
(f) repeating (b)-(e) to isolate the potential diagnostic fault associated with the relevant standard symptom; and,
(g) associating each of the isolated diagnostic faults with a desired action so as to enable recommendation of at least one desired action.

7. The method of claim 6, wherein the standard symptoms are accumulated across the electronic manual during a pre-processing phase comprising:
cleaning a semantic structure of each of the standard symptoms available across the electronic manual to extract distinct words therefrom; and,
generating a term frequency matrix with each column representing a term characterizing the distinct word and each row representing a corresponding standard symptom, wherein each entry of the term frequency matrix represents a relative weight to be accorded if any of the distinct word is found in the corresponding standard symptom.

8. The method of claim 6, wherein the correlating comprises:
cleaning a semantic structure of the observed symptom that characterizes the discrepancy report to extract distinct words therefrom;
generating a vector with each column representing a term characterizing the distinct word and a row representing corresponding observed symptom, wherein an entry of the vector represents a relative weight to be accorded if any of the distinct word is found in the corresponding observed symptom;
normalizing each entry of the vector according to following equation:

| | | |
|---|---|---|
| ent(1, j) = (1 + log(tf₁ⱼ))log(N/dfⱼ) | if | tf₁ⱼ ≧ 1 |
| ent(1, j) = 0 | if | tf1j = 0 |

wherein tf₁ⱼ represents a number of occurrences of the jth word in the observed symptom, wherein ent (1,j) represents an entry of the vector, wherein N represents an aggregate number of standard symptoms, and wherein dfⱼ represents a total number of occurrences of the term in the standard symptoms;
evaluating a distance between the vector and each row of the term frequency matrix; and,
based on the evaluation, selecting at least one standard symptom as the relevant standard symptoms correlated with the observed symptom.

9. The method of claim 8, wherein the distance is evaluated according to following equation:
Distance=a cos {(x₁y₁+x₂y₂+ . . . )/[Sqrt(x₁²+x₂²+ . . . )*Sqrt(y₁²+y₂²+ . . . )]}
wherein a cos represents a cosine inverse trigonometric relationship, wherein yᵢ represents the i^{th} entry of the row in the term frequency matrix from which distance is evaluated, wherein Sqrt represents a Square Root Mathematical operation, and wherein xⱼ represents the j^{th} entry of the vector determined from the observed symptom.

10. The method of claim 8, wherein the distinct word comprises synonyms thereof.

11. The method of claim 7, wherein the term frequency matrix is represented in a sparse matrix.

12. The method of claim 7, wherein an entry in row i and column j of the term frequency matrix is evaluated according to following equation

| Entry (i, j) = | (1 + log (tfᵢⱼ)) log (N/dfᵢ) | if | tfᵢⱼ >= 1 |
|---|---|---|---|
| | 0 | if | tfᵢⱼ = 0 |

wherein tfᵢⱼ represents the term frequency, wherein N represents a total number of standard symptoms across the electronic manual, and wherein dfⱼ represents a total number of occurrences of the distinct words in the standard symptoms.

13. A method for implementing a diagnostic system comprising:
receiving an observed symptom that characterizes a discrepancy report of a complex system, wherein the observed symptom is received by a computer implemented system;
associating the observed symptom with contents of a plurality of electronic manual conforming to a SGML format to capture relevant information therefrom; and,
evaluating the relevant information by the computer implemented system to recommend at least one corrective action for mitigation of the discrepancy report without assuming knowledge about a historical discrepancy report similar to the reported discrepancy, wherein the corrective action is evaluated from data characterizing an association of each of a plurality of standard symptoms to corresponding ones of a plurality of diagnostic faults and an association of each of the plurality of diagnostic faults to corresponding ones of a plurality of corrective actions.

14. A computer readable medium carrying one or more sequences of instruction for causing a digital processing system to implement a diagnostic system, wherein the sequences of instruction are performed by at least one processor to execute functions of:
receiving an observed symptom that characterizes a discrepancy report of a complex system;
associating the observed symptom with contents of at least one electronic manual to capture relevant information therefrom; and,
evaluating the relevant information by the digital processing system to recommend at least one desired action for mitigation of the discrepancy report without assuming knowledge about a historical discrepancy report similar to the reported discrepancy.

15. The computer readable medium of claim 14, wherein the contents of the electronic manual comprises data characterizing a plurality of standard symptoms, a plurality of potential diagnostic faults pertaining to the complex system, a plurality of desired actions representing corrective action, an association of each of the plurality of standard symptoms to corresponding ones of the plurality of diagnostic faults, and an association of each of the plurality of diagnostic faults to corresponding ones of the plurality of desired actions.

16. The computer readable medium of claim 14, wherein the electronic manual conforms to a markup language.

17. The computer readable medium of claim 16, wherein the markup language comprises a SGML structured format.

18. The computer readable medium of claim 14, wherein the functions further comprises querying the electronic manual selected from the group consisting of a trouble shooting document, a schematic manual, a maintenance manual, a parts catalogue, and a wiring manual.

19. The computer readable medium of claim 14, wherein the functions further comprises:
(a) retrieving one or more relevant standard symptoms from standard symptoms in the electronic manual by correlating the observed symptom with the standard symptoms using the digital processing system;
(b) selecting one of the relevant standard symptoms;
(c) identifying at least one potential diagnostic fault associated with the selected relevant standard symptom;
(d) determining whether the potential diagnostic fault is isolated based on an association of the fault with the relevant standard symptom;
(e) retrieving at least another standard symptom associated with the potential diagnostic fault identified at (c) in case of non-isolation thereof;
(f) repeating (b)-(e) to isolate the potential diagnostic fault associated with the relevant standard symptom; and,
(g) associating each of the isolated diagnostic faults with a plurality of desired actions to enable recommendation of at least one desired action.

20. The computer readable medium of claim 19, wherein all the standard symptoms are accumulated during a pre-processing phase comprising:
cleaning a semantic structure of each of the standard symptoms available across the electronic manual to extract distinct words therefrom; and,
generating a term frequency matrix with each column representing a term characterizing the distinct word and each row representing a corresponding standard symptom, wherein each entry of the term frequency matrix represents a relative weight to be accorded if any of the distinct words is found in the corresponding standard symptom.

21. The computer readable medium of claim 20, wherein the correlating comprises:
cleaning a semantic structure of the observed symptom that characterizes the discrepancy report to extract distinct words therefrom;
generating a vector with each column representing a term characterizing the distinct word and a row representing a corresponding observed symptom, wherein each entry of the vector represents a relative weight to be accorded if any of the distinct words is found in the corresponding observed symptom;
normalizing each entry of the vector according to following equation:

| ent(1, j) = | (1 + log(tf₁ⱼ))log(N/dfⱼ) | if | tf₁ⱼ ≧ 1 |
|---|---|---|---|
| ent(1, j) = | 0 | if | tf1j = 0 |

wherein tf₁ⱼ represents a number of occurrences of the jth word in the observed symptom, wherein ent(1,j) represents an entry of the vector, wherein N represents the aggregate number of standard symptoms, and wherein dfⱼ represents the total number of occurrences of the term in the standard symptoms;
evaluating a distance between the vector and each row of the term frequency matrix; and,
based on the evaluation, selecting at least one standard symptom as the relevant standard symptoms correlated with the observed symptom.

22. The computer readable medium of claim 21, wherein the distance is evaluated according to following equation:
Distance=a cos {(x₁y₁+x₂y₂+ . . . )/[Sqrt(x₁²+x₂²+ . . . )*Sqrt(y₁²+y₂²+ . . . )]}
wherein a cos represents a cosine inverse trigonometric relationship, wherein yi represents the ith entry of the row in the normalized term frequency matrix from which distance is evaluated, wherein Sqrt represents a Square Root Mathematical operation, and wherein xⱼ represents the jₜₕ entry of the normalized vector determined from the observed symptom.

23. The computer readable medium claim 21, wherein the distinct word comprises synonyms thereof.

24. The computer readable medium claim 20, wherein the term frequency matrix is represented in a sparse matrix.

25. The computer readable medium of claim 20, wherein an entry in row i and column j of the term frequency matrix is evaluated according to following equation:

| Entry (i, j) = | (1 + log (tfᵢⱼ)) log (N/dfⱼ) | if | tfᵢⱼ >= 1 |
|---|---|---|---|
| | 0 | if | tfᵢᵢ = 0 |

wherein tfᵢⱼ represents the term frequency, wherein N represents total number of standard symptoms across the electronic manual, and wherein dfⱼ represents total number of occurrences of the distinct words in the standard symptoms.
